(19) United States
(12) Patent Application Publication
(10) Pub. No.: US 2009/0160283 A1
(43) Pub. Date: Jun. 25, 2009

(54) Rotary/linear Drive with a Rotary Drive which is Free of Axial Forces

(76) Inventors: Erich Bott, Hollstadt (DE); Matthias Braun, Massbach (DE); Holger Schunk, Lendershausen (DE); Rolf Vollmer, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 11/719,897

(22) PCT Filed: Nov. 16, 2005
(86) PCT No.: PCT/EP05/56002

§ 371 Date: May 22, 2007

(30) Foreign Application Priority Data
Nov. 22, 2004 (DE) 10 2004 056 210.5

(51) Int. Cl. H02K 1/27; H02K 41/02

(52) U.S. Cl. 310/156.47; 310/12.14

(57) ABSTRACT

The aim of the invention is to provide a linear rotation drive wherein the oscillating torques are reduced to a minimum and whose rotation drive is devoid of axial forces. For this purpose, a magnet of the linear rotation drive is provided with sloped sections or a plurality of magnet sections is configured to give at least two sloped magnet arrangements which are symmetric to a line extending in the circumferential direction of the linear rotation drive. Oscillating torques can also be avoided by distributing the magnets across the circumference of the rotor or stator in an uneven manner. Favorable results can be obtained when the least common multiple of the number of grooves and the number of poles is as high as possible.

The present invention relates to a rotary/linear drive comprising a rotary drive device which has magnets for generating a torque in a manner which is free of axial forces.

In a combined motor for rotary movement and axial movement, that is to say in a rotary/linear drive, it is advantageous for control reasons for the motor part which generates the rotary movement to not give rise to any axial forces. In addition, the excitation of oscillating torques should be reduced, these oscillating torques originating, in the case of a permanent-magnet synchronous machine (PM synchronous machine), from the interaction between harmonic force waves of the rotor field and control value fluctuations in the used stator. High oscillating torques have an adverse effect on the rotation of the rotary drive.

The object of the present invention is therefore to simultaneously satisfy both conditions, namely of keeping the axial forces of the rotary drive as low as possible and at the same time reducing oscillating torques to the greatest possible extent.

According to the invention, this object is achieved by a rotary/linear drive comprising a rotary drive device which has magnets for generating a torque, wherein at least one magnet has at least two magnet sections which run in an inclined manner with respect to the axial direction of the rotary drive device, or a plurality of magnets are designed to form at least two magnet arrangements which run in an inclined manner and are arranged symmetrically with respect to a line which runs in the circumferential direction of the rotary drive device. The oscillating torques are advantageously reduced by the magnet sections which run in an inclined manner and the axial forces are canceled out by the symmetrical design of said magnet sections.

In accordance with a further embodiment of the present invention, said object is achieved by a rotary/linear drive comprising a rotary drive device which has magnets for generating a torque, wherein the magnets are distributed in a non-uniform manner over the circumference of the rotor and/or of the stator of the rotary drive device.

According to the invention, provision is also made of a rotary/linear drive comprising a rotary drive device which has magnets for generating a torque, wherein the smallest common multiple of the number of slots and the number of poles of the rotary drive device is greater than the number of slots multiplied by three. The oscillating torques are advantageously minimized on account of the smallest common multiple of the number of slots and the number of poles being selected to be as high as possible.

In accordance with one preferred refinement of the present invention, the magnets are realized by permanent magnets of the rotor. However, the magnets may also be electromagnets of the stator. In either case, the objective of the invention of eliminating axial forces and reducing oscillating torques can be achieved by appropriate design and/or arrangement of the magnets.

In the embodiment with the magnet sections which run in an inclined manner, permanent magnets are preferably used which are V-shaped and are arranged on the rotor of the rotary drive device such that their vertex points in the circumferential direction of the rotor. On account of this V shape, the north poles and south poles can be arranged in line in a favorable manner.

However, a plurality of permanent magnets can also be combined to form one of a large number of V-shaped magnet units of the north-pole or south-pole type, with the vertex of each magnet unit pointing in the circumferential direction of the rotor. For this embodiment, permanent magnets with standard shapes, for example square or rectangular, can be used.

The present invention will now be explained in greater detail with reference to the attached drawings, in which:

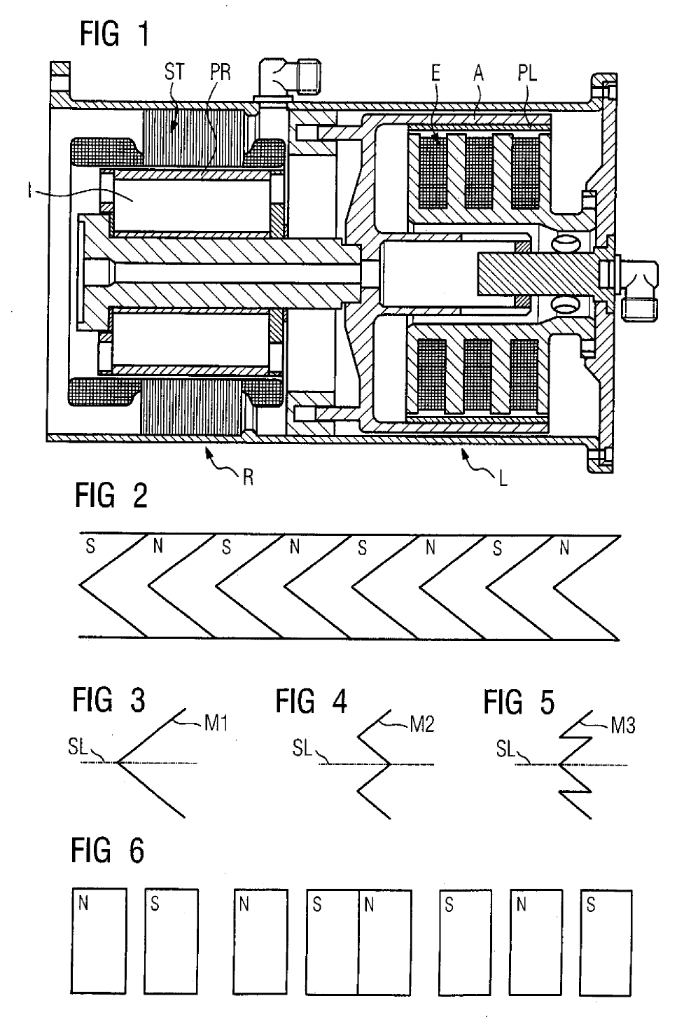

FIG. 1 shows a cross section through a rotary/linear drive;

FIG. 2 shows a magnet arrangement on a rotor according to a first embodiment;

FIG. 3 shows a basic sketch of the magnet shape from FIG. 2;

FIG. 4 shows a basic sketch of a further magnet shape with inclined sections;

FIG. 5 shows a basic sketch of yet another magnet shape with inclined sections; and

FIG. 6 shows the non-uniform distribution of rectangular permanent magnets in accordance with a further embodiment of the present invention.

The embodiments which are described in greater detail in the text which follows represent preferred exemplary embodiments of the present invention.

The combined drive or rotary/linear drive illustrated in FIG. 1 comprises a drive part R for rotation and a drive part L for the linear movement. In the present case, the linear drive L is realized by a bell-like external rotor A. Permanent magnets PL are bonded to the inner face of the external rotor A. The internal stator has electromagnets E for generating a linear force.

The rotary drive R is realized as a PM synchronous machine. Its permanent magnets PR are fixed on the internal rotor I.

In order to ensure that no axial forces occur in the event of pure rotary movement by the rotary drive, neither the stator ST nor the rotor I of the rotary drive R may be inclined, or they must be inclined such that the axial forces are compensated for. In this case, the term “inclined” means that sections of the magnets, be they the electromagnets or the permanent magnets, run in an inclined manner in relation to the axis of the rotary drive R.

In accordance with a first embodiment, the permanent magnets PR of the rotary drive R are designed with an arrow-like inclination according to FIG. 2. In this case, each component magnet, whether south pole or north pole, has an arrow-like shape or a V shape. Here, the magnets are lined up on the circumference of the internal rotor I such that their vertices lie on a circumferential line, with the result that a fishbone-like pattern is produced. North poles and south poles alternate with one another.

The oscillating torques are reduced by the limbs, which run in an inclined manner, of each magnet. Furthermore, the axial forces are canceled out by the magnets being symmetrical with respect to the center line, which runs in the circumferential direction, of the magnet arrangement. In FIG. 3, one of the magnets M is symbolically shown by two lines which run toward one another and represent the limbs of the magnet. The symmetry line SL, which runs in the circumferential direction, is also shown.

FIG. 4 shows an alternative embodiment. For all intents and purposes, two magnet arrangements from FIG. 2 or 3 are axially lined up with one another in this figure. The contour of the magnet M2 therefore has a zigzag shape. It is symmetrical with respect to the symmetry line SL. A further embodiment would involve providing three or more tines along the axial direction. In this case, the magnet M2 may be of integral design or be composed of two or more parts which have the shape of a magnet M1.

A further embodiment of the magnet arrangement according to the invention is illustrated in FIG. 5. The magnet M3 is symmetrical with respect to the symmetry line SL in this case too. The contours above the symmetry line SL run from bottom left to top right in two stages, and the contours below the symmetry line SL likewise run in two stages from bottom right to top left. The intention of this exemplary important is merely to show that any desired contours, which run in an inclined manner, of the magnets are possible in order to reduce oscillating torques and compensate for axial forces. In the embodiments presented above, the axial forces are compensated for by symmetry of contour of the magnets with respect to a symmetry line which runs in the circumferential direction.

Instead of providing the individual magnets with an arrow-like inclination, the inclination can also be achieved by a large number of individual magnets, which have a square or rectangular contour for example, being arranged to form a contour which runs in an inclined manner. In this case too, oscillating torques are reduced by virtue of the inclined offset of the individual magnets with respect to the axial direction. As a result of a symmetrical arrangement again in relation to a circumferential line, the axial forces are superposed such that they are eliminated.

FIG. 6 shows a further embodiment of the magnet arrangement according to the invention. In the example presented in said figure, axial forces are avoided from the very start on account of the individual magnets N, S having a rectangular shape, with their sides being oriented either perpendicular or parallel to the axial direction of the rotary drive and each magnet having a uniform shape over the entire axial extent of the magnet arrangement of the stator or rotor. The oscillating torques are reduced by the individual magnets being distributed in a non-uniform manner over the circumference of the rotor of the rotary drive. In an analogous manner, the slots can also be distributed in a non-uniform manner over the circumference of the stator.

However, the oscillating torques can also be reduced by the smallest common multiple of the number 2p of poles of the rotor and the number N1 of slots of the stator being selected to be as high as possible. Favorable results can be achieved as early as when this smallest common multiple is greater than 3×N1. One example of a magnet arrangement in which the oscillating torques are sufficiently low would be: N1=27 and 2p=8. The smallest common multiple would then be 8×27=216.

1.-7. (canceled)

8. A rotary/linear drive, comprising a rotary drive device having magnets for generating a torque; wherein at least one magnet has at least two magnet sections which extend in an inclined manner with respect to an axial direction of the rotary drive device.

9. The rotary/linear drive of claim 8, wherein the magnets are permanent magnets of a rotor of the rotor drive device.

10. The rotary/linear drive of claim 8, wherein the magnets are electromagnets of a stator of the rotor drive device.

11. The rotary/linear drive of claim 8, wherein the magnets are permanent magnets which are V-shaped and are arranged on a rotor of the rotary drive device such that their vertex points in a circumferential direction of the rotor.

12. The rotary/linear drive of claim 8, wherein the magnets are permanent magnets, and a plurality of permanent magnets are combined to form one of a large number of V-shaped magnet units of a north-pole or south-pole type, wherein a vertex of each magnet unit points in a circumferential direction of a rotor of the rotor drive device.

13. A rotary/linear drive, comprising a rotary drive device having magnets for generating a torque; wherein a plurality of magnets are designed to form at least two magnet arrangements which extend in an inclined manner and are arranged symmetrically with respect to a line which extends in a circumferential direction of the rotary drive device.

14. The rotary/linear drive of claim 13, wherein the magnets are permanent magnets of a rotor of the rotor drive device.

15. The rotary/linear drive of claim 13, wherein the magnets are electromagnets of a stator of the rotor drive device.

16. The rotary/linear drive of claim 13, wherein the magnets are permanent magnets which are V-shaped and are arranged on a rotor of the rotary drive device such that their vertex points in a circumferential direction of the rotor.

17. The rotary/linear drive of claim 13, wherein the magnets are permanent magnets, with each of the magnet arrangements having a V-shaped configuration of a north-pole or south-pole type, wherein a vertex of each magnet arrangement points in a circumferential direction of a rotor of the rotor drive device.
